(19) United States
(12) Patent Application Publication
(10) Pub. No.: US 2024/0402454 A1
(43) Pub. Date: Dec. 5, 2024

(54) HYBRID FIBER AND POWER CABLING CONNECTIVITY SYSTEMS

(71) Applicant: THE LAN WIREWERKS RESEARCH LABORATORIES INC., Baie-d’Urfé (CA)

(72) Inventors: Simon VIGNEAULT, Rigaud (CA); Edouard TABET, St-Phillipe (CA); Philippe SAUMURE, Dorval (CA)

(73) Assignee: THE LAN WIREWERKS RESEARCH LABORATORIES INC., Baie-d’Urfé (CA)

(21) Appl. No.: 18/680,723

(22) Filed: May 31, 2024

Related U.S. Application Data
(60) Provisional application No. 63/470,253, filed on Jun. 1, 2023.

(51) Int. Cl. G02B 6/44; H01R 13/518

(52) U.S. Cl. CPC G02B 6/4471; G02B 6/4416; H01R 13/518

(57) ABSTRACT

The present invention provides a hybrid fiber and power cabling system comprising a patch panel comprising a module enclosure having four module docking slots configured to accommodate up to three modules, and at least two removable modules which include at least one fiber/patch module and at least one power/conductor module to provide a hybrid patch panel having both fiber and power connectivity that is suitable for use in combination with hybrid fiber/copper cables. The system can be deployed in central locations to provide high-performance fiber networking with electrical power to remote devices through the communications infrastructure.

### FIELD OF THE INVENTION

The present invention pertains to the field of fiber optics and in particular to the deployment of fiber optic cables with powering capability.

### BACKGROUND

Deployment of In-Building Wireless (IBW) Small Cell or Distributed Antenne Systems (DAS), Wi-Fi access points, HD cameras, Building Automation System (BAS) devices, optical network terminals, and other IP-enabled remote devices is commonplace in our connected world.

Today, Power over Ethernet (POE) is widely used for remote device powering and communications; however distance limitations, power availability, and remote device placement often present challenges beyond the capabilities of PoE cabling systems.

There is therefore a need for cabling systems which can be deployed to provide high-performance fiber networking with electrical power to remote devices through the communications infrastructure.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide hybrid fiber and power cabling connectivity systems. In accordance with an aspect of the present invention, there is provided a hybrid fiber and power cabling system comprising: a patch panel/rack unit (RU) comprising a module enclosure having four module docking slots, wherein each module docking slot is configured to accommodate up to three modules; and at least two removable modules, wherein the at least two modules comprise at least one fiber/patch module and at least one power/conductor module, wherein the at least one fiber module and the at least one power module are located in the module docking slots.

In accordance with another aspect of the present invention, there is provided a power module comprising: a housing having a first (forward) end and a second (rearward) end, and a first lateral edge and a second lateral edge, the housing comprising: a planar base extending between said first end and said second end; a side member located on each of said first lateral edge and said second lateral edge; a plurality of wire splice connectors located in the housing between the first end and the second end, the array being located within the housing.

In accordance with another aspect of the present invention, there is provided a kit comprising: a patch panel/rack unit (RU) comprising a module enclosure having four module docking slots, wherein each module docking slot is configured to accommodate up to three modules; a plurality of fiber modules; and a plurality of power modules.

### BRIEF DESCRIPTION OF THE FIGURES

FIG. 1A illustrates a perspective view of an exemplary hybrid cabling connectivity system configuration, in accordance with one embodiment of the present invention.

FIG. 1B illustrates a front view of the hybrid cabling connectivity system configuration of FIG. 1A, in accordance with one embodiment of the present invention.

FIG. 2 illustrates a perspective view of the hybrid cabling connectivity system configuration of FIG. 1A, with a schematic overlay of the power and fiber connectivity, in accordance with one embodiment of the present invention.

FIG. 3 illustrates a perspective view of an exemplary hybrid cabling connectivity system configuration, in accordance with one embodiment of the present invention.

FIGS. 4A and 4B illustrate a perspective view of power modules for use with the hybrid cabling connectivity system, in accordance with embodiments of the present invention.

FIG. 5A illustrates a perspective view of a power module for use with the hybrid cabling connectivity system of the present invention, in accordance with one embodiment.

FIG. 5B illustrates an exploded perspective view of the power module of FIG. 5A.

FIG. 6 illustrates a perspective view of one embodiment of a fiber module suitable for use with the hybrid cabling connectivity system of the present invention, in accordance with one embodiment.

FIG. 7 illustrates a perspective view of one embodiment of a fiber module suitable for use with the hybrid cabling connectivity system of the present invention, in accordance with one embodiment.

FIGS. 8A-E illustrate a front view of different configurations of different hybrid cabling connectivity system configurations, in accordance with embodiments of the present invention.

### DETAILED DESCRIPTION OF THE INVENTION

The terms “cable”, “fiber cable” and “fiber optic cable” are used interchangeably in the present specification.

The terms “fiber module” and “patch module” are used interchangeably in the present specification.

The terms “power module” and “conductor module” are used interchangeably in the present specification.

The abbreviations “LC” and “SN” refer to types of fiber-optic connectors. In accordance with the present invention, the fiber connectors can be LC or SN connectors.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a hybrid fiber and power connectivity system comprising a hybrid patch panel configured to accommodate both fiber and power modules.

The hybrid cable systems of the present invention utilize hybrid patch panels in combination with hybrid fiber/copper cables which together can be deployed in central locations to provide high-performance fiber networking with electrical power to remote devices through the communications infrastructure.

The hybrid cabling systems of the present invention provide easy-to-install, cost-saving, rack-to-remote powered fiber cabling over extended distances, and are suitable for use in In-Building Wireless (IBW), Wi-Fi, HD camera and Building Automation Systems (BAS) applications.

The hybrid systems of the present invention minimize costs and delays that can result from running power to remote devices. They also allow installation of remote devices (DAS, small cell antennas, security cameras, etc.) in their optimal locations for best communication coverage without compromises due to less-than-optimal locations necessary to access power sources.

Deployment of one hybrid cable for both telecommunication and power also eliminates the need to provide separate telecom and power infrastructure installed by different technicians/contractors.

The patch panel/rack unit of the present hybrid cable connectivity systems has a module enclosure with four module docking slots. The system is configured to accommodate any combination of fiber and power modules according to the requirements of the end user. In order to provide the hybrid fiber/power capability of the present systems, the system includes at least one fiber/patch module and at least one power/conductor module.

Accordingly, the hybrid system of the present invention includes a minimum of two and a maximum of twelve modules located in the module docking slots of the rack unit (RU).

In a preferred embodiment, each module docking slot in the module enclosure is configured to accommodate up to three modules, providing a total capacity of up to 12 modules/RU.

In one embodiment, where the rack unit is configured to accommodate up to 12 modules, the number of fiber modules is x and the number of power modules is y, wherein each of x and y is independently an integer from 1 to 11, and wherein (x+y) is an integer from 2 to 12. In accordance with the present invention, a rack unit therefore will accommodate at least one power module and at least one fiber module. The remaining spaces in the rack unit may contain any combination of power and fiber modules, or may remain unoccupied.

The system of the present invention provides great flexibility for achieving different combinations of fiber and power connections within a single rack unit, as well as the capability of achieving high connectivity density in a small footprint. For example, in a rack unit having a capacity to accommodate up to 12 modules, the use of 11×12F fiber modules and 1×12C power modules provides a fiber density of 132F/RU and a power density of 12C/RU. The fiber density in this configuration can be further doubled through the use of SN connectors to provide an effective fiber density of up to 264F/RU. In a similar manner, the use of 1×12F fiber modules in combination with 11×12C power modules provides a fiber density of 12F/RU and a power density of 132C/RU. The number of fiber and power modules used together can be varied to achieve any desired combination of fiber and power density.

In one embodiment, a fiber module is adapted to receive up to 12 optical fiber connectors (12F). In one embodiment, a fiber module is adapted to receive up to 24 optical fiber connectors (24F).

In one embodiment, a power module is adapted to receive up to 12 power connectors (12C). In one embodiment, a power module is adapted to receive up to 8 power connectors (8C).

In one embodiment, each fiber module is adapted to receive up to n optical fiber connectors, wherein n equals 12 or 24, and wherein each power module is adapted to receive up to m power connectors, wherein m equals 12.

In one embodiment, the number of fiber connections F per rack unit=x×n; and the number of power connections C per rack unit=y×m.

In one embodiment, when the fiber module comprises n=12 optical fiber connectors (12F), at least one of the module docking slots may contain one to three fiber modules.

In one embodiment, when the fiber module comprises n=24 optical fiber connectors (24F), at least one of the module docking slots may contain one fiber module.

In one embodiment, when the power module comprises m=8 power connectors (8C), at least one of the module docking slots may contain one to three power modules.

In one embodiment, when the power module comprises m=12 power connectors (12C), at least one of the module docking slots may contain one power module.

Each of the modules is configured to slide into the module docking slots for convenient installation and removal of the modules from the patch panel. To facilitate the sliding installation and removal, each module is provided with a linear guide rail on an external surface configured for sliding engagement with complementary sliding guides located in the module docking slots of the patch panel.

In accordance with the present invention, the hybrid system further comprises at least one hybrid cable having a fiber subunit comprising optical fibers and a power subunit comprising copper conductor cables.

In another aspect of the present invention, there is provided a power module suitable for use with the hybrid system of the present invention. The power module comprises a housing that is configured to slide into the module docking slots.

The housing has first (forward) and second (rearward) ends, and a planar base extending between said first end and said second ends. The housing also has first and second lateral edges, and side members located on each of the lateral edges. A plurality of wire splice connectors is located within the housing.

In a preferred embodiment, each side member comprises linear guiding rails on an external surface configured for sliding engagement with complementary sliding guides in the power module docking slots.

In one embodiment, the power module further comprises a front cable guide located on the forward end of the housing, and a rear cable guide located on the rearward end of the housing.

In one embodiment, the fiber/patch modules and power/conductor modules are provided with a large label plate to document each module's exact internal configuration and wiring diagram. In a preferred embodiment, the label plate is configured to slide out for viewing access without requiring removal of the module itself from the docking slot or disturbing the module's optical or power connections.

In one embodiment, the present invention provides a kit which includes all components required to assemble a hybrid system having the number of fiber and power connections according to the user's requirements. In one embodiment, the kit comprises a patch panel comprising a module enclosure having four module docking slots, a plurality of fiber modules and a plurality of power modules.

In one embodiment of the kit of the present invention, the plurality of fiber modules comprises at least one 12F fiber module and/or at least one 24F fiber module. In one embodiment of the kit of the present invention, the plurality of power modules comprises at least one 8C power module and/or at least one 12C power module.

The hybrid cabling connectivity system of the present invention employs a standardized rackmount enclosure/patch panel that is compatible with all power and fiber modules. The interchangeability of the fiber and power modules allows for the re-use of modules and reduces sparing.

In a preferred embodiment, the kit of the present invention also includes a selection of fiber pigtail(s), as well as installation hardware and installation instructions.

All configurations can be assembled using the standard patch panel of the present invention and various combinations of the power and fiber modules, which reduces technician training and improves installation quality.

In a preferred embodiment, the patch panel of the present invention and all power and fiber modules include integrated cable attachment, strain-relief, routing, bend-radius protection and fiber management features for reliability and installed performance.

The hybrid system of the present invention is suitable for use with single-mode and multimode fiber, UPC/APC/PC, fusion-splicing, pre-term and field-term connectors for application and installation flexibility.

The invention will now be described with reference to specific examples as shown in the figures. It will be understood that the following examples are intended to describe embodiments of the invention and are not intended to limit the invention in any way.

### Examples

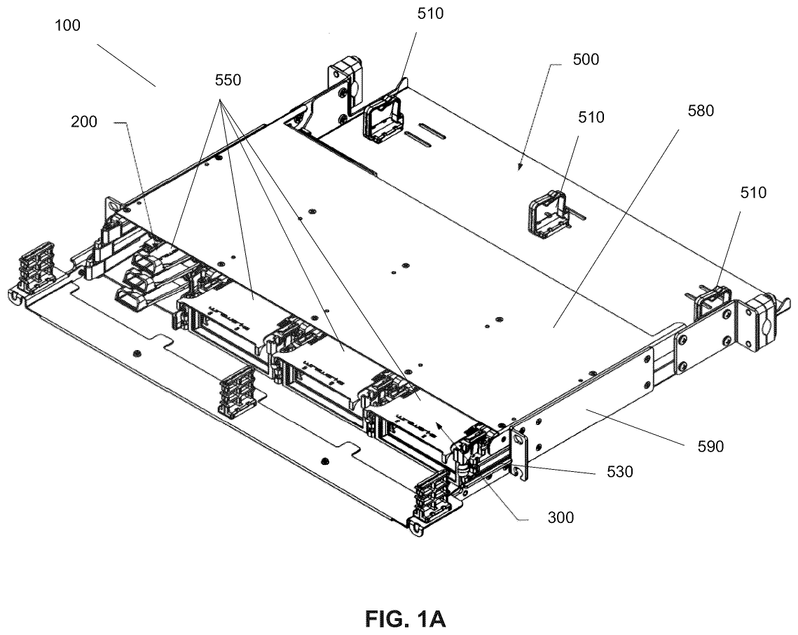

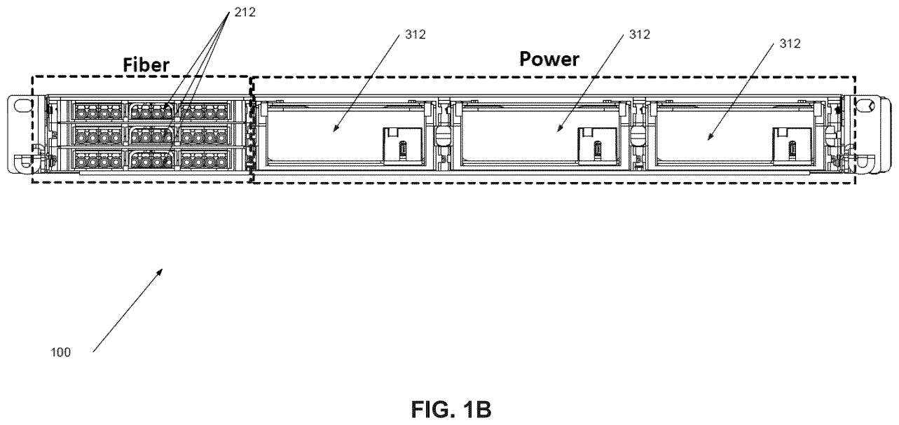

An exemplary hybrid cabling connectivity system configuration 100 is shown in FIGS. 1A and 1B. This system employs a patch panel 500 having an industry standard 19″ wide footprint that is provided with module enclosure 580 which has four module docking slots 550. Each of these slots can accommodate a fiber/patch module 200, a power module 300, or a combination of both. Patch panel 500 is provided with mounting bracket 590 for attachment to a rack (not shown).

FIG. 1B illustrates a front view of the hybrid cabling connectivity system configuration of FIG. 1A, in accordance with one embodiment of the present invention.

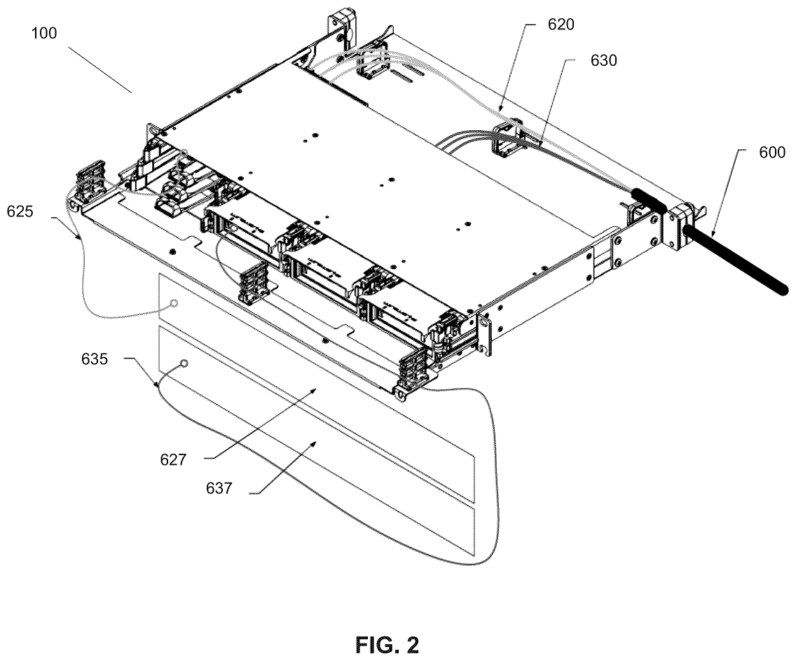

FIG. 2 depicts hybrid cabling connectivity system configuration 100 shown in FIG. 1A, with a schematic overlay of the power and fiber connectivity, including hybrid cable 600, which includes fiber subunit 620 and power subunit 630. Fiber subunit 620 patches through respective fiber modules via patch cord 625 to active equipment 627, and power subunit 630 connects through respective power modules via power conductors 635 to a power source 637.

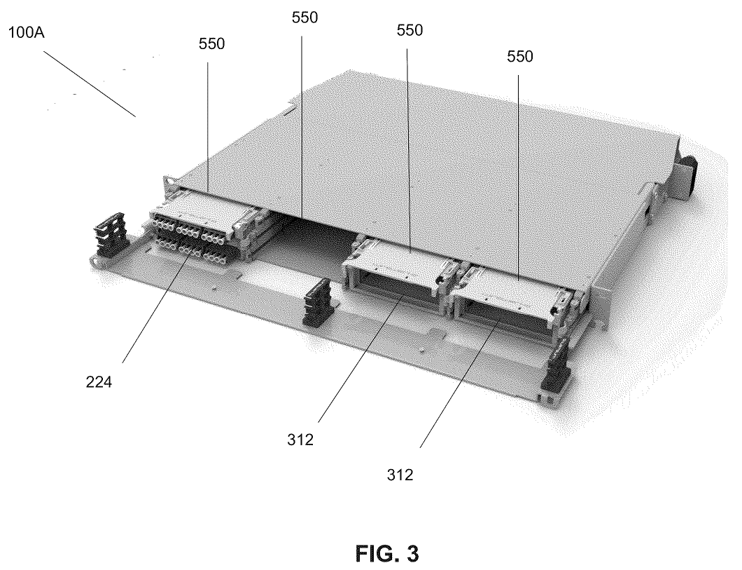

FIG. 3 depicts an example of a hybrid cabling connectivity system configuration 100A, in which one of the docking slots 550 is occupied by 24F fiber module 224, two of the docking slots 550 are each occupied by 12C power module 312, and the remaining docking slot 550 is unoccupied. This configuration provides an overall 24F/24C hybrid system.

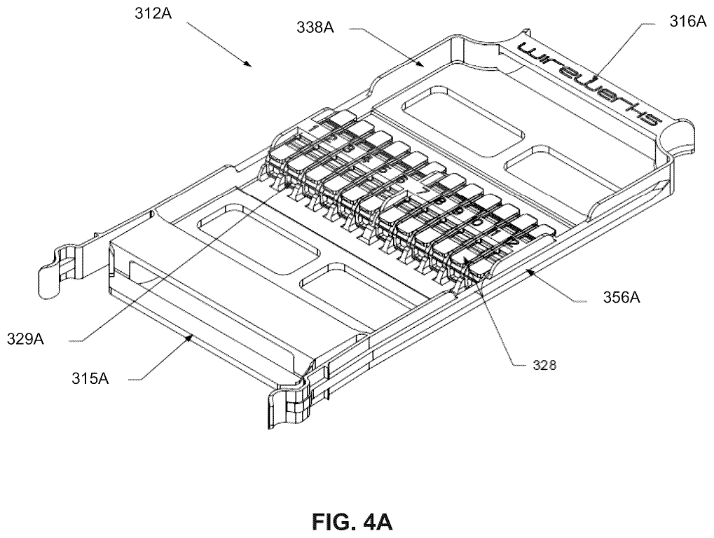

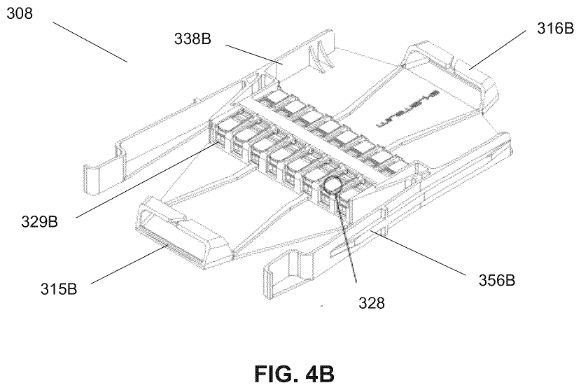

FIG. 4A depicts an exemplary 12C power module 312A suitable for use with the hybrid cabling connectivity system. Shown is housing 338A having twelve wire splice connectors 328 situated in splice connector seats 329A extending transversely across the width of the housing. The sides of housing 338A comprise linear guiding rails 356A on the external surface configured for sliding engagement with complementary sliding guides in the module docking slots (not shown). Power module 312A also includes front cable guide 315A and rear cable guide 316A, which serve to retain the power conductors (not shown) in place.

FIG. 4B depicts an exemplary 8C power module 308 suitable for use with the hybrid cabling connectivity system. Shown is housing 338B having eight wire splice connectors 328 situated in splice connector seats 329B extending transversely across the width of the housing. The sides of housing 338B comprise linear guiding rails 356B on the external surface configured for sliding engagement with complementary sliding guides in the module docking slots (not shown). Power module 312B also includes front cable guide 315B and rear cable guide 316B, which serve to retain the power conductors (not shown) in place.

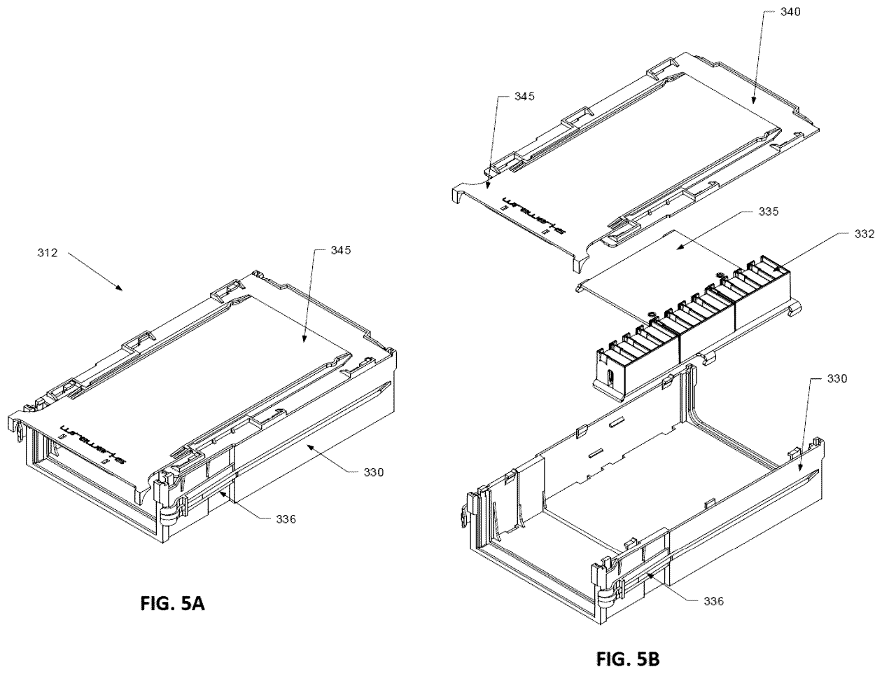

FIGS. 5A and 5B depict an exemplary 12C power module 312 suitable for use with the hybrid cabling connectivity system. Shown is housing 330 and cover 340 with sliding label plate 345. Located in housing 330 is 12C terminal block 332, which is mounted in adapter brackets 335. The sides of housing 330 comprise linear guiding rails 336 on the external surface configured for sliding engagement with complementary sliding guides in the module docking slots (not shown).

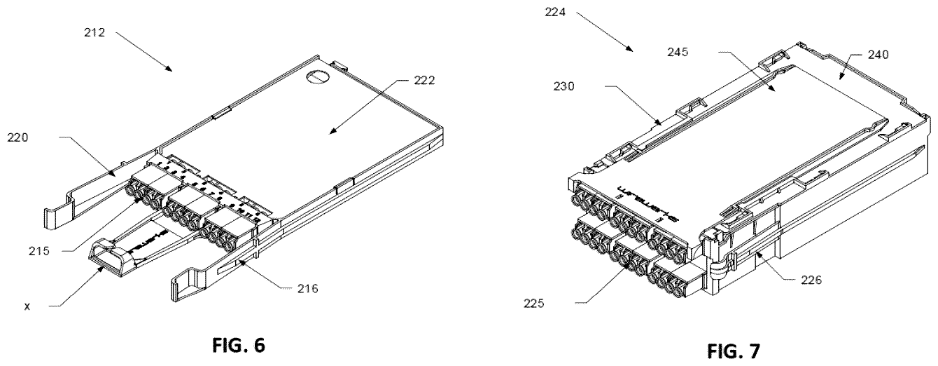

FIG. 6 depicts an exemplary 12F fiber module 212 suitable for use with the hybrid cabling connectivity system. Shown is housing 220 and cover 222. Located at the front of the housing is 12F fiber adapter 215 and extending outwardly from the front of housing 230 is cable guide 255. The sides of housing 230 comprise linear guiding rails 216 on the external surface configured for sliding engagement with complementary sliding guides in the module docking slots (not shown).

FIG. 7 depicts an exemplary 24F fiber module 224 suitable for use with the hybrid cabling connectivity system. Shown is housing 230 and cover 242 with sliding label plate 245. Located at the front end of housing 230 is 24F fiber adapter 225. The sides of housing 230 comprise linear guiding rails 226 on the external surface configured for sliding engagement with complementary sliding guides in the module docking slots (not shown).

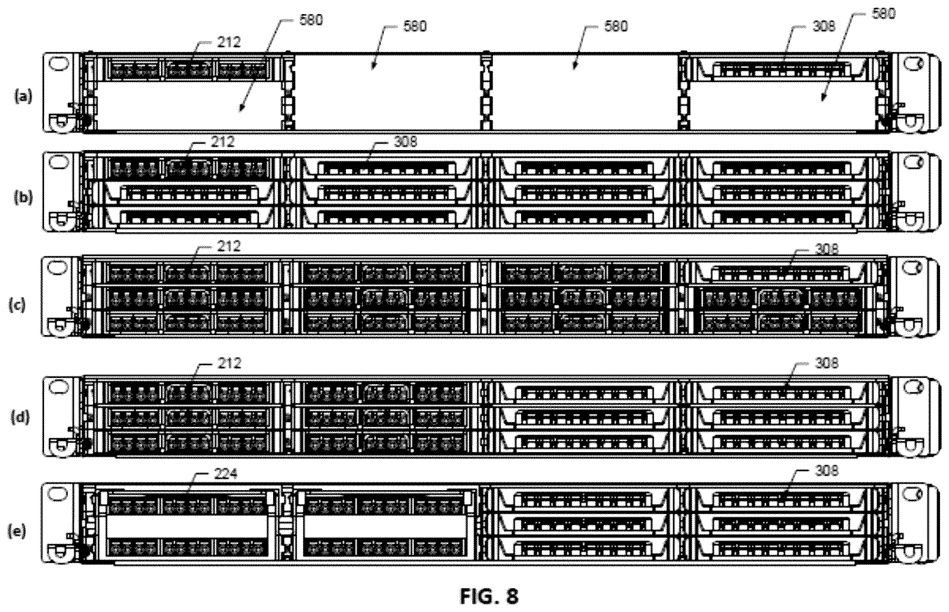

FIGS. 8A-E illustrate front views of different configurations that can be achieved using the components of hybrid cabling connectivity system of the present invention. FIG. 8A depicts a 12F/8C hybrid system including one 12F fiber module 212 in one module docking slot 580 and one 8C power module 308 in another docking slot 580 and two empty docking slots 580. FIG. 8B depicts a 12F/88C hybrid system including one 12F fiber module 212 and eleven 8C power module 308. FIG. 8C depicts a 132F/8C hybrid system including eleven 12F fiber modules 212 and one 8C power module 308. As shown in the embodiments of FIGS. 8B and 8C, a combination of fiber and power modules can be provided within the same docking slot. FIG. 8D depicts a 72F/48C hybrid system including six 12F fiber modules 212 and six 8C power module 308. FIG. 8E depicts a 48F/48C hybrid system including two 24F fiber modules 224 and six 8C power module 308.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A hybrid fiber and power cabling system comprising:
a patch panel comprising a module enclosure having four module docking slots, wherein each module docking slot is configured to accommodate up to three modules; and
at least two removable modules, wherein the at least two modules comprise at least one fiber/patch module and at least one power/conductor module, wherein the at least one fiber module and the at least one power module are located in the module docking slots.

2. The cabling system of claim 1, wherein the at least two modules comprise two to twelve modules, wherein the number of fiber modules is x and the number of power modules is y, wherein each of x and y is independently an integer from 1 to 11, and wherein (x+y) is an integer from 2 to 12.

3. The cabling system of claim 2, wherein each fiber module is adapted to receive up to n optical fiber connectors, wherein n equals 12 or 24, and wherein each power module is adapted to receive up to m power connectors, wherein m equals 12.

4. The cabling system of claim 3, wherein:
the number of fiber connections F per rack unit (RU)=x×n; and
the number of power connections C per rack unit (RU)=y×m.

5. The cabling system of claim 3, wherein the fiber connectors are LC connectors, the number of fiber modules is 1 to 11, the number of fiber connectors per module is 12, and the fiber density value is from 12F/RU to 132F/RU.

6. The cabling system of claim 3, wherein the fiber connectors are SN connectors, the number of fiber modules is 1 to 11, the number of fiber connectors per module is 12, and the fiber density value is from 24F/RU to 264F/RU.

7. The cabling system of claim 3, wherein the number of power modules is 1 to 11, the number of power connectors per power module is 12, and the power density value is from 12C/RU to 132C/RU.

8. The system of claim 1, wherein at least one of said module docking slots contains one to three fiber modules, each said fiber module comprising n=12 optical fiber connectors.

9. The system of claim 1, wherein at least one of said module docking slots contains one fiber module, said fiber module comprising n=24 optical fiber connectors.

10. The system of claim 1, wherein at least one of said module docking slots contains one to three power modules, said power module comprising m=8 power connectors.

11. The system of claim 1, wherein at least one of said module docking slots contains one to three power modules, said power module comprising m=12 power connectors.

12. The system of claim 1, further comprising at least one hybrid cable having a fiber subunit comprising optical fibers and a power subunit comprising copper conductor cables.

13. A power module comprising:
a housing having a first end and a second end, and a first lateral edge and a second lateral edge, the housing comprising:
a planar base extending between said first end and said second end;
a side member located on each of said first lateral edge and said second lateral edge;
a plurality of wire splice connectors located in the housing between the first end and the second end, the array being located within the housing.

14. The power module of claim 13, wherein each said side member comprises linear guiding rails on an external surface configured for sliding engagement with complementary sliding guides in the power module docking slots.

15. The power module of claim 13, further comprising a front cable guide located on the first end of the housing.

16. The power module of claim 13, further comprising a rear cable guide located on the second end of the housing.

17. A kit comprising:
a patch panel/rack unit (RU) comprising a module enclosure having four module docking slots, wherein each module docking slot is configured to accommodate up to three modules;
a plurality of fiber modules; and
a plurality of power modules.

18. The kit of claim 17, wherein the plurality of fiber modules comprises at least one 12F fiber module and/or at least one 24F fiber module, and the plurality of power modules comprises at least one 8C power module and/or at least one 12C power module.
